(19) United States
(12) Patent Application Publication
(10) Pub. No.: US 2022/0018189 A1
(43) Pub. Date: Jan. 20, 2022

(54) LADDER SUPPORT APPARATUS

(71) Applicant: Jason Coulter, Camdenton, MO (US)

(72) Inventor: Jason Coulter, Camdenton, MO (US)

(21) Appl. No.: 17/413,309

(22) PCT Filed: Dec. 13, 2019
(86) PCT No.: PCT/US19/66291

§ 371 Date: Jun. 11, 2021

Related U.S. Application Data
(60) Provisional application No. 62/779,134, filed on Dec. 13, 2018.

(51) Int. Cl. E06C 1/18; E06C 1/38; E06C 7/44; E06C 7/46

(52) U.S. Cl. CPC E06C 1/18; E06C 7/46; E06C 7/44; E06C 1/38

(57) ABSTRACT

A ladder support apparatus provides support and stability to a ladder. The ladder support apparatus includes a bracket, a friction-reducing segment, and a friction-inducing segment. The bracket is configured to be secured to a leg of the ladder. The friction-inducing segment is secured to the bracket and configured to interface with an underlying surface when the ladder support apparatus is in a default orientation relative to the underlying surface. The friction-reducing segment is secured to the bracket and configured to interface with the underlying surface when the ladder support apparatus is in an angled orientation relative to the underlying surface.

### RELATED APPLICATIONS

This patent application claims priority benefit, with regard to all common subject matter, of commonly owned U.S. provisional patent application Ser. No. 62/779,134, filed Dec. 13, 2018, and entitled “LADDER SUPPORT ATTACHMENT.” This previously filed application is hereby incorporated by reference in its entirety into the present application.

### FIELD OF THE INVENTION

The present disclosure generally relates to ladders and the stabilization and mobilization thereof.

### BACKGROUND

Ladders support a user thereon such that the user may perform various tasks from an elevated location. Ladders, however, are typically top-heavy when a user is standing thereon. The top-heaviness can cause wobbling or “walking” of the ladder (e.g., rocking from side to side while the user is on the ladder). The ladder may also be needed in numerous floor surfaces (generally referred to herein as an “underlying surface”). Thus, stability of the ladder is a consideration. Many existing ladders lack proper stability to support a user thereon. Further, to move a ladder, a user must typically lift the ladder off the underlying surface and carry the ladder to a desired location or orientation. This can be difficult as ladders are often large, heavy, and difficult to carry (and the user is also often also carrying other tools or equipment). What is lacking in the prior art is a device to selectively stabilize and mobilize a standard ladder.

This background discussion is intended to provide information related to the present invention which is not necessarily prior art.

### BRIEF SUMMARY

Embodiments of the invention solve the above-mentioned problem by providing a ladder support apparatus. The ladder support attachment is configured to enhance the mobility, the stability, and the load support of a ladder. Embodiments of the present invention improve support and stability of the ladder by providing improved contact of the legs with the ground surface. Such improved contact of the legs reduces wobble of the ladder during use and inhibits “walking” of the ladder, which is a known problem for standard ladders. In general, the ladder support attachment may be configured for use with an A-frame type ladder (e.g., a 1A or 1AA step ladder). In some specific embodiments, the ladder support attachment may be used on a front step ladder, which includes steps on its front side (i.e., extending between its front legs) and support rungs on its back side (i.e., extending between its rear legs). However, embodiments provide for the ladder support attachment to be universal, such that it may be used with various other ladder types (e.g., multipurpose ladders, articulated ladders, platform ladders, step stools, etc). In addition, the ladder support attachment may be configured to be used on ladders of various sizes, such as 8, 10, or 12 foot ladders (or even larger/smaller ladders). Thus, the inventive ladders support attachment is configured to be universal, such that the ladder support attachment can be used with generally any type of ladder type, ladder size, and/or ladder brand, and may be configured to be supplied as a standard component with ladders as sold from a manufacturer.

A first embodiment of the invention is generally directed to a ladder support apparatus for providing support and stability to a ladder, said ladder support apparatus comprising a bracket, a friction-reducing segment, and a friction-inducing segment. The bracket is configured to be secured to a leg of the ladder. The friction-inducing segment is secured to the bracket and configured to interface with an underlying surface when the ladder support apparatus is in a default orientation relative to the underlying surface. The friction-reducing segment is secured to the bracket and configured to interface with the underlying surface when the ladder support apparatus is in an angled orientation relative to the underlying surface.

A second embodiment of the invention is generally directed to ladder support apparatus for providing support and stability to a ladder, said ladder support apparatus comprising a bracket, a friction-reducing segment, and a friction-inducing segment. The bracket is configured to be secured to a leg of the ladder, and includes a lateral support plate, a first sidewall, and a second sidewall. The lateral support plate is configured to receive a foot of the leg of the ladder thereon. The first sidewall and the second sidewall each extend downward from the lateral support plate. The friction-inducing segment is secured to the bracket and configured to interface with an underlying surface when the ladder support apparatus is in a default orientation relative to the underlying surface. The friction-reducing segment is secured to the bracket and configured to interface with the underlying surface when the ladder support apparatus is in an angled orientation relative to the underlying surface.

A third embodiment of the invention is generally directed to a ladder support system for providing support and stability to a ladder. The ladder includes a set of primary legs and a set of support legs. The ladder support system includes a first ladder support apparatus and a second ladder support apparatus. The first ladder support apparatus has a first orientation configured to be secured to a first support leg of the set of support legs of the ladder. The second ladder support apparatus has a second orientation configured to be secured to a second support leg of the set of support legs of the ladder. The first orientation is mirrored relative to the second orientation. The first ladder support apparatus and the second ladder support apparatus both include the above-discussed bracket, friction-reducing segment, and friction-inducing segment. The friction-inducing segment is configured to interface with an underlying surface when the ladder support apparatus is in a default orientation relative to the underlying surface. The friction-reducing segment is configured to interface with the underlying surface when the ladder support apparatus is in an angled orientation relative to the underlying surface.

Additional embodiments of the invention may be directed to a ladder having a ladder support apparatus permanently affixed thereto. The ladder of these embodiments may be originally manufactured to include the above-discussed structures of the ladder support apparatus. In other embodiments, the ladder may be sold with the ladder support apparatus permanently secured thereto such as via welding or a chemical adhesive.

Advantages of these and other embodiments will become more apparent to those skilled in the art from the following description of the exemplary embodiments which have been shown and described by way of illustration. As will be realized, the present embodiments described herein may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals. The present embodiments are not limited to the precise arrangements and instrumentalities shown in the Figures.

FIG. 1 is a perspective view of a ladder having a first embodiment of a ladder support system installed on two support legs of the ladder, shown from an upper side;

FIG. 2 is a perspective view of the ladder and ladder support system of FIG. 1, shown from a lower side;

FIG. 3 is a side view of the ladder of FIG. 1, shown in an angled orientation so as to allow mobility of the ladder;

FIG. 4 is a perspective view of a ladder support apparatus of embodiments of the invention, shown from an upper side;

FIG. 5 is a perspective view of the ladder support apparatus of FIG. 4, shown from a lower side and with a portion removed to illustrate a positioning segment;

FIG. 6 is an exploded view of the ladder support apparatus of FIG. 4;

FIG. 7 is a vertical cross-sectional view showing the ladder support apparatus secured to a foot of the ladder;

FIG. 8 shows an alternative embodiment of the positioning segment;

FIG. 9 shows a ladder having a second embodiment of a ladder support system installed on the support legs;

FIGS. 10A and 10B show an alternative embodiment of the ladder support apparatus having support rails; and

FIG. 11 shows an alternative embodiment of a securing fastener.

The Figures depict exemplary embodiments for purposes of illustration only. One skilled in the art will readily recognize from the following discussion that alternative embodiments of the systems and methods illustrated herein may be employed without departing from the principles of the invention described herein. While the drawings do not necessarily provide exact dimensions or tolerances for the illustrated components or structures, the drawings, not including any purely schematic drawings, are to scale with respect to the relationships between the components of the structures illustrated therein.

### DETAILED DESCRIPTION

The present invention is susceptible of embodiment in many different forms. While the drawings illustrate, and the specification describes, certain preferred embodiments of the invention, it is to be understood that such disclosure is by way of example only. There is no intent to limit the principles of the present invention to the particular disclosed embodiments. For instance, the drawing figures do not limit the present invention to the specific embodiments disclosed and described herein. Furthermore, directional references (for example, top, bottom, up, and down) are used herein solely for the sake of convenience and should be understood only in relation to each other. For instance, a component might in practice be oriented such that faces referred to as “top” and “bottom” are sideways, angled or inverted relative to the chosen frame of reference.

### Exemplary Field of Use

Before discussing a ladder support apparatus 10 in detail, an exemplary ladder or system in which it may be utilized will be discussed. It should be appreciated that the ladder discussed herein and shown in the figures is a merely exemplary environment. The ladder support apparatus 10 may be utilized in any of numerous practical applications.

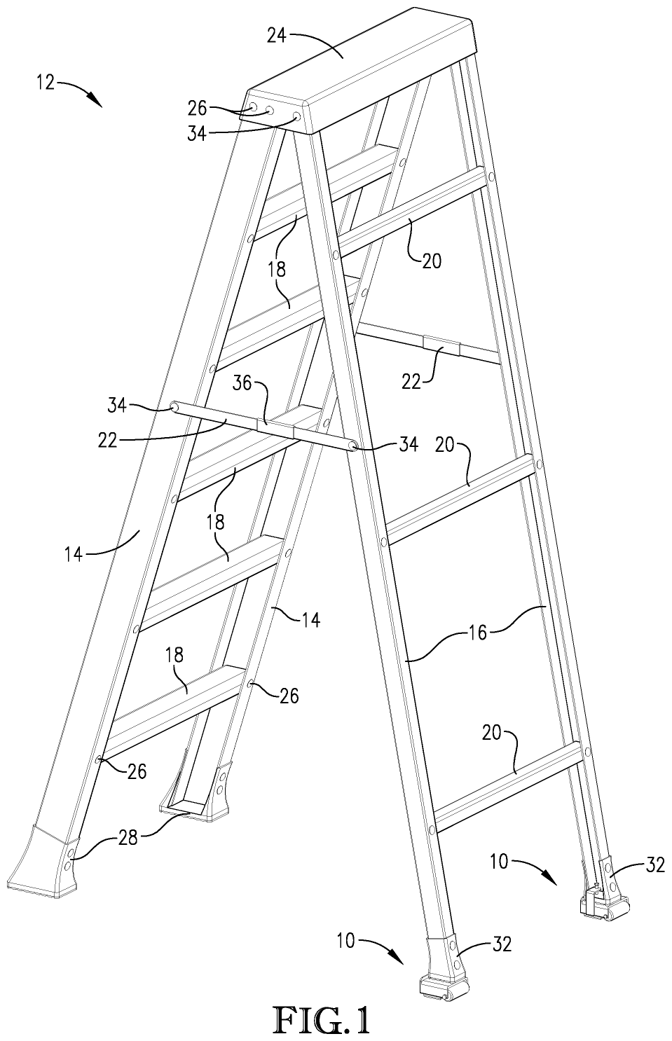

Turning to FIG. 1, an exemplary ladder utilizing embodiments of the invention is shown. The ladder provides an exemplary field of use for various embodiments of the invention. Other embodiments of the invention may be utilized in other fields of use. Practically any object with legs, such as a table, stepstool, desk, or other furniture (not illustrated) can be utilized with various embodiments of the invention to allow for stability and mobility of the object. These various embodiments may thus be configured to allow for securing to the respective objects.

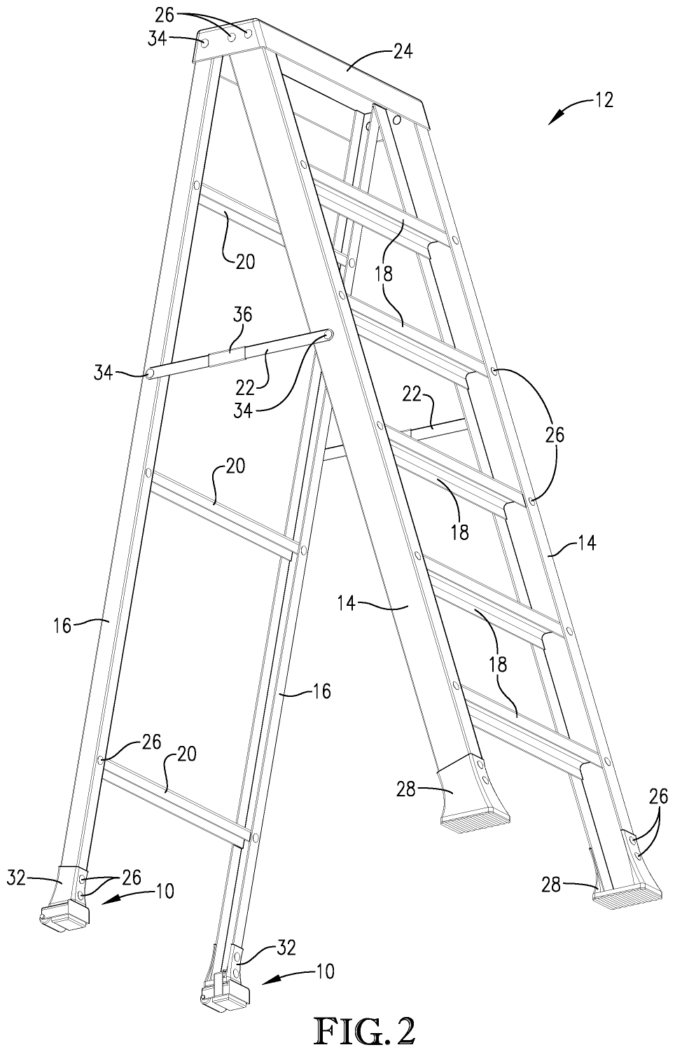

An exemplary embodiment of a ladder 12 is shown in FIGS. 1 and 2. This type of ladder 12 may be commonly referred to as a step ladder. A ladder 12, to which embodiments of the invention (as discussed below) are configured to be secured, may include a set of primary legs 14, a set of support legs 16, a set of step rungs 18, a set of support rungs 20, a set of spreaders 22, and a top cap 24. Other ladders may include some combination of these structures, as well as other structures.

The primary legs 14 are spaced by the step rungs 18 as well as the top cap 24. The step rungs 18 and the top cap 24 are secured to the primary legs 14 by fasteners 26. The primary legs 14 each include a primary foot 28, configured to be placed on an underlying surface 30. The support legs 16 are spaced by the support rungs 20 as well as the top cap 24. The support rungs 20 and the top cap 24 are secured to the support legs 16 by fasteners 26. The support legs 16 each include a support foot 32, configured to be placed on the underlying surface 30. The support feet 32 are configured to be interfaced by the ladder support apparatus 10, as discussed in detail below.

In the exemplary ladder 12, the ladder 12 may be in a stowed configuration or a deployed configuration. The ladder 12 of FIGS. 1-3 is shown in the deployed configuration. In the deployed configuration, the spreader 22 is secured so as to push the support legs 16 away from the primary legs 14. The support legs 16 are typically secured to the top cap 24 via a pivotable fastener 34, such that the support legs 16 can be brought to substantially parallel with the primary legs 14 in the stowed configuration. The spreader 22 may also include pivotable fasteners 34 as well as a lock 36 to keep the spreader 22 (and by extension, the entire ladder 12) in the deployed configuration.

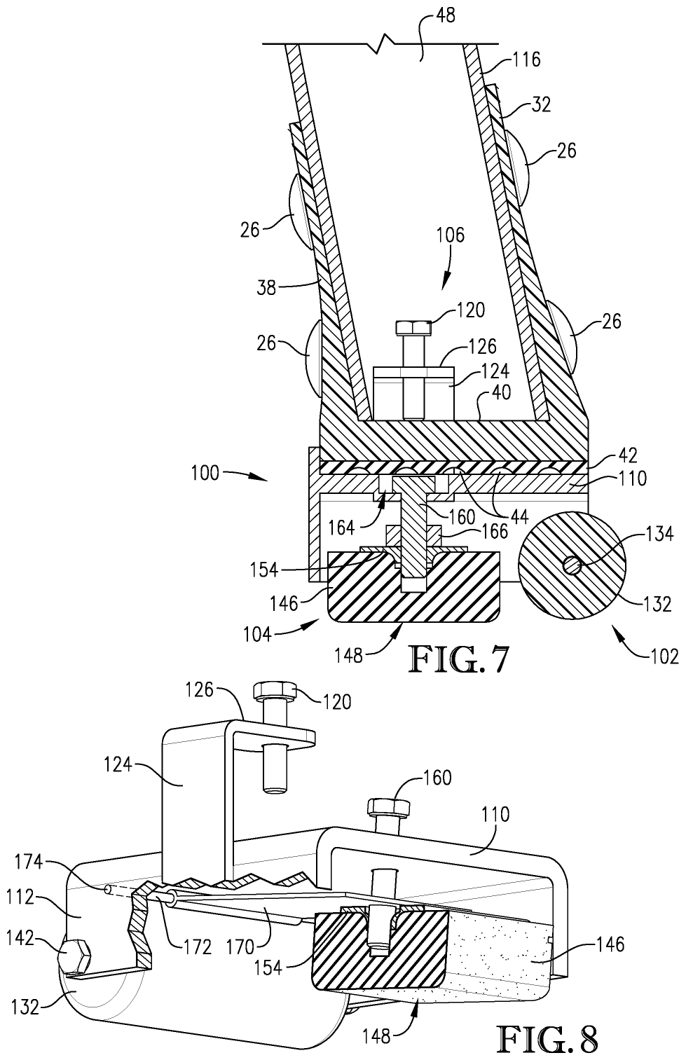

The foot 32 of the support leg is shown in more detail in FIG. 7. The foot 32 includes a flange 38 and a base 40 configured to fit over the support leg 16 of the ladder. The flange 38 flares outward to increase a surface area of a floor pad 42 affixed to a bottom side of the base 40 of the foot 32. The floor pad 42 is configured to interface with the underlying surface 30 (although embodiments of the invention will be placed between the floor pad 42 and the underlying surface 30). The floor pad 42 of some embodiments includes recesses 44 configured to increase the friction with the underlying surface 30. The floor pad 42 presents outer edges 46 to which embodiments of the invention will be secured, as discussed below. It should be appreciated that an inner channel 48 of the support leg 16 may be open for securing of the various embodiments of the invention, as discussed below.

In general, the ladder support apparatus 10 discussed below may be configured for use with an A-frame type ladder (e.g., a 1A or 1AA step ladder). In some specific embodiments, the ladder support apparatus 10 may be used on a front step ladder, which includes steps on its front side (i.e., extending between its primary legs 14) and support rungs 20 on its back side (i.e., extending between its support legs 16). However, embodiments provide for the ladder support apparatus 10 to be universal, such that it may be used with various other ladder types (e.g., multipurpose ladders, extension ladders, articulated ladders, platform ladders, step stools, etc.). In addition, the ladder support apparatus 10 may be configured to be used on ladders of various sizes, such as eight-, ten-, or twelve-foot ladders (or even larger/smaller ladders).

### Exemplary Ladder Support Apparatus 10

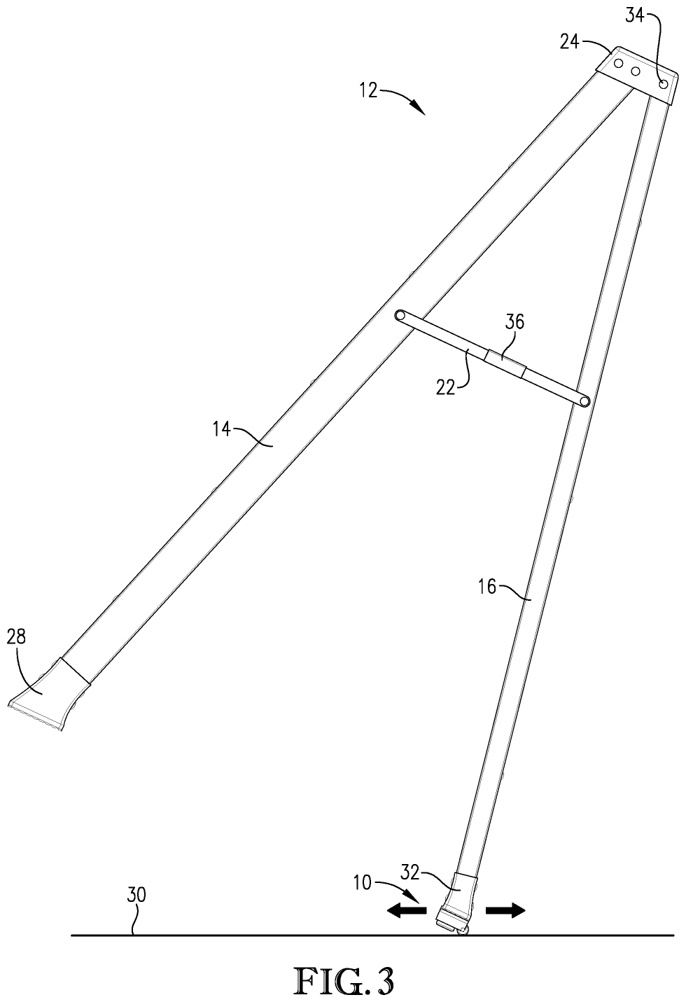

Turning to FIGS. 3-6, an exemplary ladder support apparatus 10 is shown. As discussed above, the ladder support apparatus 10 is configured to provide mobility and stability to the ladder 12. The ladder support apparatus 10 provides mobility while the ladder 12 is tipped in a first orientation and provides stability while the ladder 12 is in a second orientation. An example of the first orientation is shown in FIG. 3 in which the ladder 12 is angled relative to an underlying surface 30. The mobility arrows of FIG. 3 show how the ladder 12 is mobile while in this orientation. While ladder support apparatus 10 is shown providing mobility of ladder 12 in a deployed configured in FIG. 3, it is understood that the mobility of ladder 12 described herein may also be achieved when the ladder 12 is in a partially or completely stowed configuration. That is, in a partially or completely stowed configuration, the spreader 22 is partially or completely collapsed, unextended, or the like, so that support legs 16 may be selectively located relative to the primary legs 14 or substantially parallel therewith. Thus, ladder support apparatus 10 also provides mobility (e.g., as shown with the mobility arrows of FIG. 3) while ladder 12 is tipped in a first orientation and in a partially or completely stowed configuration. An example of the second orientation is shown in FIGS. 1 and 2, in which the ladder 12 has all four legs flat against the underlying surface 30 (not directly illustrated). Thus, the user can selectively switch between a mobile ladder 12 and a stable ladder 12 by altering the angle of the ladder 12 relative to an underlying surface 30.

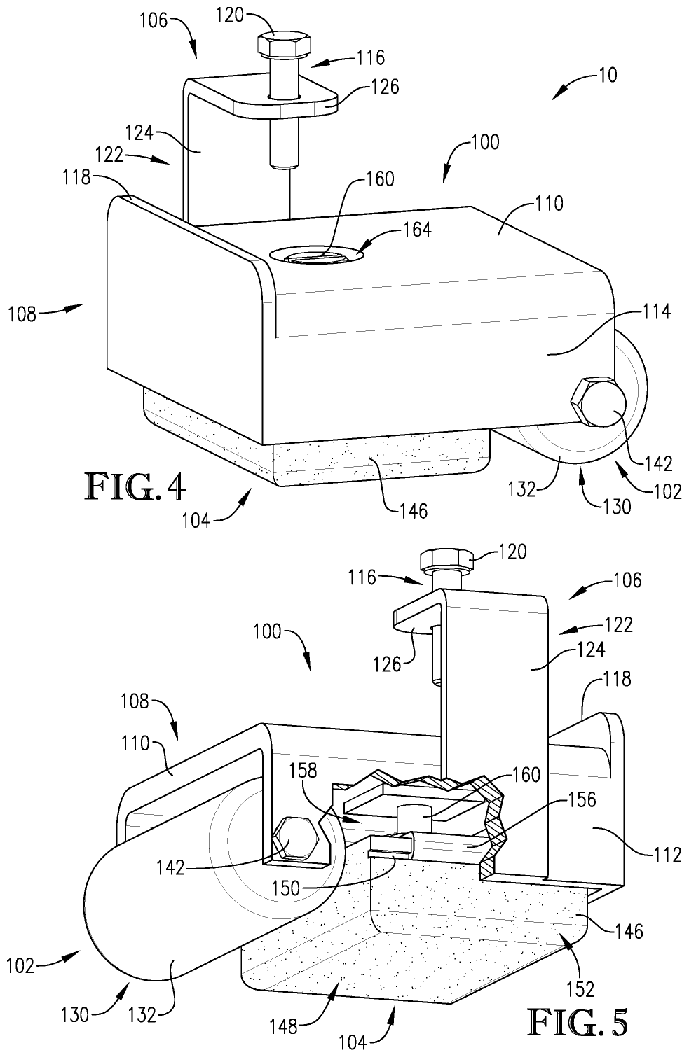

In embodiments of the invention, as best shown in FIGS. 4-5, the ladder support apparatus 10 comprises a bracket 100, a friction-reducing segment 102, and a friction-inducing segment 104. The friction-reducing segment 102 and the friction-inducing segment 104 are each secured to the bracket 100. The bracket 100 is configured to be secured to the ladder 12. The bracket 100 thus secures the friction-reducing segment 102 and the friction-inducing segment 104 relative to the ladder 12 such that the friction-reducing segment 102 and the friction-inducing segment 104 may be selectively interfaced with the underlying surface 30 depending upon the above-discussed angle relative to the underlying surface 30. In embodiments of the invention, the ladder support apparatus 10 may only comprise a bracket 100 and a friction-reducing segment 102. In other embodiments of the invention, the ladder support apparatus 10 may only comprise a bracket 100 and a friction-inducing segment 104.

In embodiments, the bracket 100 is configured to be secured to a leg of the ladder 12. More specifically, in some embodiments, the bracket 100 may be made of steel, fiberglass, carbon fiber, alloys, or other suitable resilient material, and is configured to be secured to a foot of the leg of the ladder 12. Even more specifically, in some embodiments, the bracket 100 is configured to be secured to a support foot 32 of a support leg 16 of the ladder 12. This is illustrated in FIGS. 1-3. The friction-inducing segment 104 is configured to interface with an underlying surface 30 when the ladder support apparatus 10 is in a default orientation relative to the underlying surface 30 (as in FIGS. 1-2). The friction-reducing segment 102 is configured to interface with the underlying surface 30 when the ladder support apparatus 10 is in an angled orientation relative to the underlying surface 30 (as in FIG. 3).

In embodiments of the invention, the bracket 100 includes a ladder-securing segment 106 and structural-support segment 108. The ladder-securing segment 106 is configured to fasten the ladder 12 to the ladder support apparatus 10. The structural-support segment 108 is configured to keep the friction-inducing segment 104 and the friction-reducing segment 102 secured to and aligned with the bracket 100. The structural-support segment 108 of the bracket 100 may include a lateral support plate 110, a first sidewall 112, and a second sidewall 114.

In embodiments of the invention, the ladder-securing segment 106 comprises a securing fastener 116 and an alignment plate 118. The securing fastener 116 is configured to hold to exert a force of the foot 32 of the ladder 12. The securing fastener 116 may selectively or permanently lock the ladder-support apparatus to the foot 32. The securing fastener 116 may have any of numerous embodiments. In the example shown in FIGS. 4 and 5, the securing fastener 116 includes a bolt 120 and an arm 122. The arm 122 rises from the later support plate and/or the first sidewall 112. The arm 122 includes a vertical segment 124 and a horizontal segment 126. The bolt 120 extends from the horizontal segment 126 of the arm 122 so as to exert the force downward to push the foot 32 into the lateral support plate 110. The user may thus tighten the bolt 120 onto the foot 32 of the ladder 12 (as shown in FIG. 1). The user may secure the tightened bolt 120 using a locking nut (not illustrated) or other locking device. In some embodiments, the user may permanently secure the bolt 120 in the locked position.

In other embodiments, other structures may be utilized as the securing fastener 116. In some embodiments, mechanical pressure may be provided by a clamp. In other embodiments, mechanical pressure may be provided by a spring, such as a compression spring, an extension spring, a torsional spring, a leaf spring, a disc spring, or a constant-force spring. In still other embodiments, mechanical pressure may be provided by another structure. The securing may also be accomplished via a chemical adhesive, welding, or other permanent securement.

In embodiments of the invention, the alignment plate 118 extends upward from a lateral support plate 110. The alignment plate 118 includes a wall 128 having side edges and a top edge. The alignment plate 118 keeps the foot 32 of the ladder 12 aligned with the bracket 100. An edge of the foot 32 is placed against the wall of the alignment plate 118. Then, as the ladder support apparatus 10 is secured to the foot 32 by the above-discussed ladder-securing segment 106, the foot 32 remains in that orientation relative to the wall, as best shown in FIG. 7. The alignment ensures that as the ladder 12 is tipped from the default orientation to the angled orientation, the interfacing switches from the friction-inducing segment 104 to the friction-reducing segment 102.

In some embodiments, the arm 122 of the ladder-securing segment 106 is a secondary alignment plate 118. The arm 122 also keeps the foot 32 aligned with the ladder-support apparatus. As illustrated in FIGS. 4 and 5, the alignment plate 118 and the arm 122 may be disposed perpendicular such that the square- or -rectangular-shaped foot 32 may be in contact with two edge surfaces of the foot 32. This allows the securing of different sized foots for different size ladders, so long as the foot 32 is substantially square or rectangular. In other embodiments, additional alignment plate 118s may be utilized, such as a tertiary alignment plate 118 and a quaternary alignment plate 118. These additional alignment plate 118s may be selectively or permanently emplaced to secure the foot 32.

The lateral support plate 110 is configured to receive the foot 32 of the leg of the ladder 12 thereon. The lateral support plate 110 is disposed horizontally, or substantially horizontally, in the default orientation. The foot 32 is placed onto the lateral support plate 110 and aligned via the one or more alignment plate 118s discussed above. The lateral support plate 110 supports the weight of the ladder 12 and the user thereon.

The first sidewall 112 extends downward (e.g., generally towards the underlying surface 30) from the lateral support plate 110. The second sidewall 114 also extends downward (e.g., generally towards the underlying surface 30) from the lateral support plate 110. The first sidewall 112 and the second sidewall 114 provide structural stability for the lateral support plate 110. The first sidewall 112 and the second sidewall 114 also may provide securing of the friction-reducing segment 102 and/or the friction-inducing segment 104. The first sidewall 112 may be secured to the above-discussed arm 122 so as to keep the arm 122 stable relative to the other components of the bracket 100.

The friction-reducing segment 102 will now be discussed in more detail. The friction-reducing segment 102 is secured to the bracket 100. As discussed above, the friction-reducing segment 102 is configured to interface with the underlying surface 30 when the ladder support apparatus 10 is in an angled orientation relative to the underlying surface 30, as best shown in FIG. 3. This allows the user to roll or slide the ladder 12 while the ladder 12 is in the angled orientation. The friction-reducing segment 102 may include any of various friction-reducing materials or structures configured to allow this mobility.

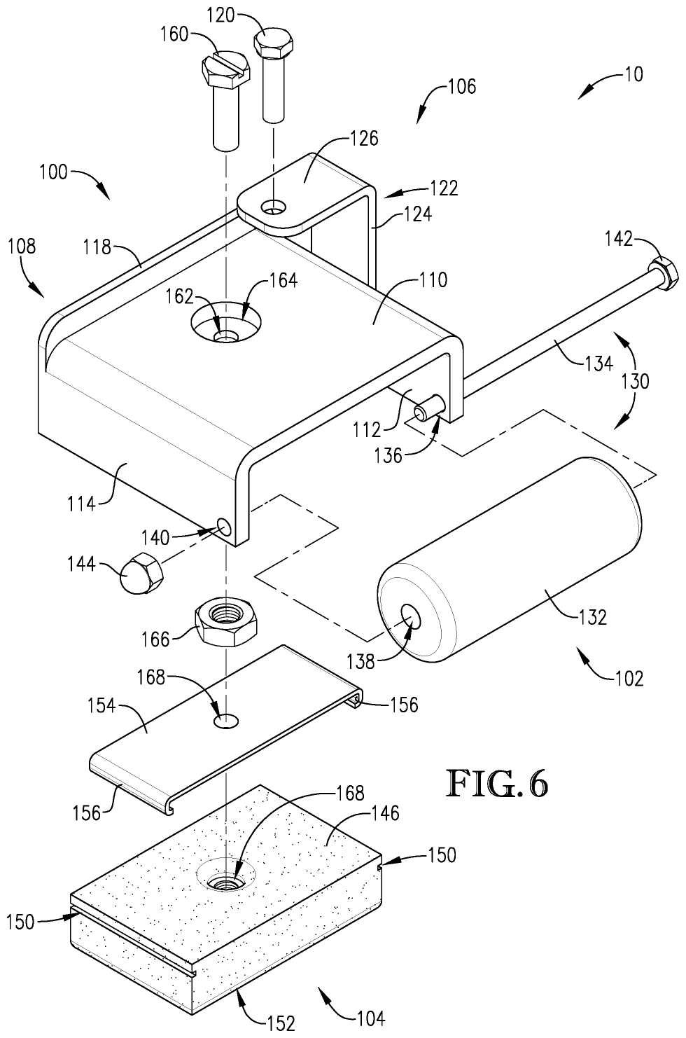

In embodiments of the invention, the friction-reducing segment 102 includes a roller 130 rotatable about an axis running between the first sidewall 112 and the second sidewall 114. In embodiments of the invention, the friction-reducing segment 102 may be comprised of Delrin®, other acetal homopolymer materials, or any other material that may present low-friction and/or high-wear resistance characteristics. The roller 130 includes a cylindrical wheel 132 and an axle 134, as best shown in FIG. 6. The cylindrical wheel 132, as shown in FIG. 6, may present a height (e.g., a height of the cylinder shape, which is a width when oriented horizontally) greater than its diameter. In some embodiments, the height of the cylinder may be at least twice the diameter, or at least three times the diameter. The height of the cylinder keeps the ladder 12 laterally stable while the ladder 12 is in the angled orientation. In other embodiments, a plurality of wheels 132 may be utilized to provide this lateral stability. It should be appreciated, as illustrated in FIGS. 1 and 2, that two ladder support apparatuses 10 may be used simultaneously on two support legs 16 of the ladder 12. As such, narrower rollers 130 may also be utilized because of the lateral support between two disparate rollers 130 on the respective ladder support apparatuses 10.

As best shown in FIG. 6, the axle 134 is disposed through a first opening 136 in the first sidewall 112, through a central passageway 138 of the cylindrical wheel 132, and through a second opening 140 in the second sidewall 114. Thus, the axle 134 allows the cylindrical wheel 132 to roll relative to the first sidewall 112 and the second sidewall 114. The axle 134 may include a first endcap142 and a second endcap 144. The first endcap 142 and the second endcap 144 keep the axle 134 secured around the first opening 136 and the second opening 140, respectively. In some embodiments, the second endcap 144 is a head of a bolt and the first endcap 142 is a nut secured to the bolt.

It should be appreciated that the rounded wall of the cylindrical wheel 132 may be locally friction-inducing (e.g., by the cylindrical wheel 132 being in contact with the underlying surface 30). However, the overall friction between the ladder 12 and the underlying surface 30 is greatly reduced because the roller 130 allows the ladder 12 to move at a reduced friction. The roller 130 enhances mobility of the ladder 12 by allowing the ladder 12 to roll relative to the underlying surface 30. It should also be appreciated that the roller 130 enhances mobility of the ladder 12 while the ladder 12 is in the stowed configuration discussed above.

The friction-inducing segment 104 is secured to the bracket 100, as best shown in FIGS. 5 and 7. The friction-inducing segment 104 is configured to interface with the underlying surface 30 when the ladder support apparatus 10 is in a default orientation relative to the underlying surface 30. The default position is the position in which the user will climb the ladder 12 to perform any of various tasks. On an A-frame ladder, this is the default deployed orientation of the ladder 12, shown in FIGS. 1 and 2. The default deployed orientation typically will include the foot 32 horizontal and the support leg 16 extending at an angle therefrom, towards and at the same angle as the primary legs 14.

In embodiments of the invention, the friction-inducing segment 104 includes a frictional pad 146, best shown in FIG. 6. The frictional pad 146 is formed of a substance selected to increase the friction between the ladder 12 and the underlying surface 30. The frictional pad 146 is configured to reduce mobility of the ladder 12 when the ladder 12 is in the default orientation, such that the user may climb the ladder 12.

In embodiments of the invention, the frictional pad 146 presents a generally rectangular prism shape including a bottom, interfacing surface 148. The bottom interfacing surface 148 is generally flat so as to maximize surface area in contact with the underlying surface 30. The frictional pad 146 may also present a channel 150 (shown in FIGS. 5 and 6) for mounting and/or aligning of the frictional pad 146. The frictional pad 146 may further present beveled corners 152 against the interfacing surface 148 to reduce wear on corners of the interfacing surface 148.

In embodiments of the invention, the frictional pad 146 includes a mounting segment 154. The mounting segment 154 is configured to secure the frictional pad 146 relative to the bracket 100. In embodiments, the frictional pad 146 is secured to the lateral support plate 110. The first sidewall 112 and second sidewall 114 of the bracket 100 may keep the frictional pad 146 aligned. In other embodiments, the frictional pad 146 may be secured to the first sidewall 112, the second sidewall 114, the alignment plate 118, or some portion of the bracket 100. The mounting segment 154 may also present clips 156 configured to be secured to the channel 150 of the frictional pad 146. In other embodiments, the frictional pad 146 may be secured to the mounting segment 154 via various fasteners, chemical adhesives, or the like.

In some embodiments, the frictional pad 146 is replaceable, such that the frictional pad 146 may be renewed upon the frictional pad 146 becoming worn or damaged. In this way, the user may keep the frictional pad 146 in good working order. This is in contrast with a standard foot 32, which is not replaceable or renewable.

In some embodiments, the friction-inducing segment 104 (or the bracket 100) further includes a positioning segment 158. The positioning segment 158 is configured to keep the frictional pad 146 at a set distance relative to the bracket 100. The positioning segment 158 allows the user to customize the angle which is considered the angled orientation. By using the positioning segment 158 to position the frictional pad 146, the user can increase or reduce the angle at which the friction-reducing segment 102 will be in contact with the underlying surface 30 (as opposed to the friction-inducing segment 104 which is in contact at the default orientation). The positioning segment 158 may also allow the ladder support apparatus 10 to be utilized with multiple different ladders (each having different orientations, foot sizes, and other distinctions).

The set distance, at which the positioning segment 158 keeps the frictional pad 146 relative to the bracket 100, is determined based at least in part on the angled orientation of the ladder 12. The user may select the set distance by manipulating the positioning segment 158. In some embodiments, the user may do so through trial-and-error by testing the ladder 12 at various settings. In other embodiments, the user may select a certain setting or set distance on the positioning system based upon a known set distance for the specific type of ladder 12 to which the user is securing the ladder support apparatus 10.

In some embodiments, the set distance is determined such that the roller 130 not only provides mobility in the angled orientation but also provides stability for the ladder 12. In these embodiments, the four legs 14,16 of the ladder 12 on the underlying surface 30 will have the roller 130 in contact with the underlying surface 30. Then, the user will induce a slight forward movement until the frictional pad 146 makes contact with the underlying surface. Thus, the user may position the positioning segment 158 such that the roller 130 is in contact until the forward movement places the frictional pad 146 in contact.

In some embodiments, best illustrated in FIG. 6, the positioning segment 158 includes a fastener 160 with helical protrusions (not directly illustrated) disposed at least partially through an opening 162 in the lateral support plate 110. The opening 162 in the lateral support plate 110 may include a recess 164 configured to sink the fastener 160 such that a flat surface is presented for receipt of the foot 32 thereon. The fastener 160 is associated with a nut 166 configured to keep the frictional pad 146 at said set distance. The fastener 160 may be secured to the mounting segment via an opening 168 of the friction-inducing segment 104, such that rotation of the fastener 160 tightens or loosens the fastener 160 secured to the mounting segment. The first sidewall 112 and the second sidewall 114 prevent the frictional pad 146 from rotating (as best shown in FIG. 5).

A ladder support system will now be discussed. The ladder support system comprises two or more of the above-discussed ladder support apparatuses 10. The ladder support system thus provides support and stability to two or more legs of the ladder 12. The ladder 12, as discussed above, includes a set of primary legs 14 and a set of support legs 16.

A first ladder support apparatus 10 has a first orientation configured to be secured to a first support leg of the set of support legs 16 of the ladder 12. A second ladder support apparatus 10 has a second orientation configured to be secured to a second support leg of the set of support legs 16 of the ladder 12. It should be appreciated that the first orientation is horizontally mirrored relative to the second orientation. The mirroring of the first orientation and the second orientation allows the friction-reducing segments 102 to be disposed toward a rear side (e.g., away from the primary legs 14) of the ladder 12. Thus, embodiments of the invention may sell a first ladder support apparatus 10 and a second ladder support apparatus 10 as a mirrored set.

Both the first ladder support apparatus 10 and said second ladder support apparatus 10 each include the bracket 100, the friction-reducing segment 102, and the friction-inducing segment 104. The friction-inducing segment 104s of both ladder support apparatuses 10 are configured to interface with the underlying surface 30 when the ladder support apparatus 10 is in a default orientation relative to the underlying surface 30. As such, the ladder 12 will be supported by the two primary feet 28 under the primary legs 14 and the two friction-inducing segments 104 under the support legs 16. Similarly, the friction-reducing segments 102 are configured to interface with the underlying surface 30 when the ladder support apparatus 10 is in an angled orientation relative to the underlying surface 30.

Turning to FIG. 8, an alternative embodiment of the positioning segment 158 is shown. In this embodiment, the positioning element includes a pivoting plate 170 that is associated with a pin 172. The pivoting plate pivots about the pin 172 and a pivot point 174. The pin 172 is disposed between the first sidewall 112 and the second sidewall 114. The pin 172 is secured such that the pivoting plate may move upward and downward in an arcing motion (as contrasted with the lateral motion of the embodiment of FIG. 5). The pivoting plate 172 may help ensure that the interfacing side 148 of the frictional pad 146 remains fully in contact with the underlying surface 30 (of FIG. 3) when the ladder 12 is in the default orientation.

### Additional Embodiments

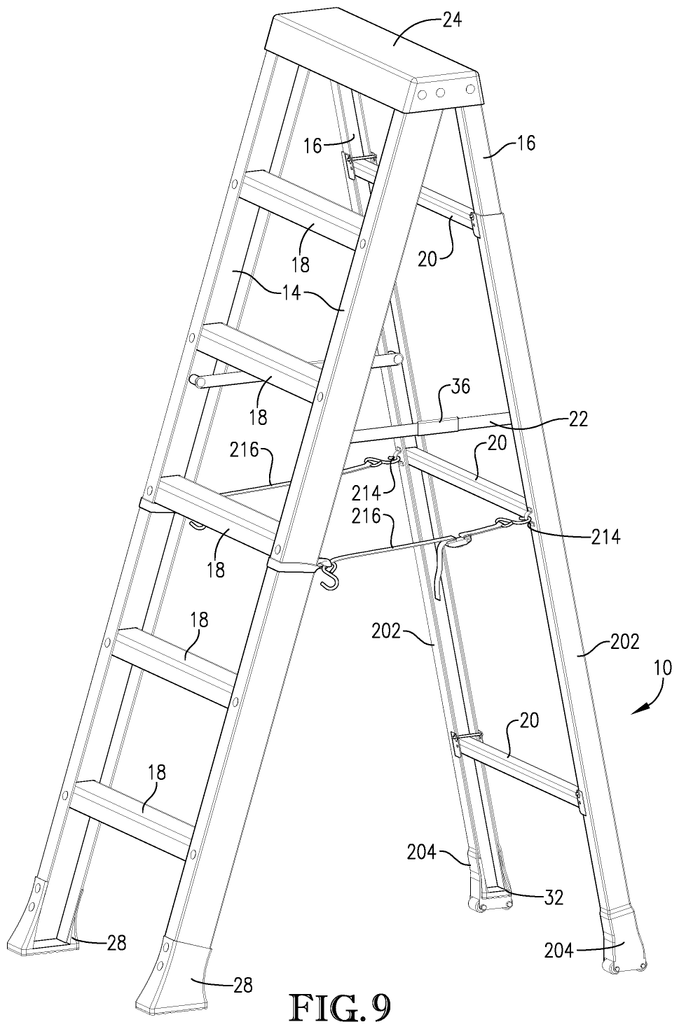

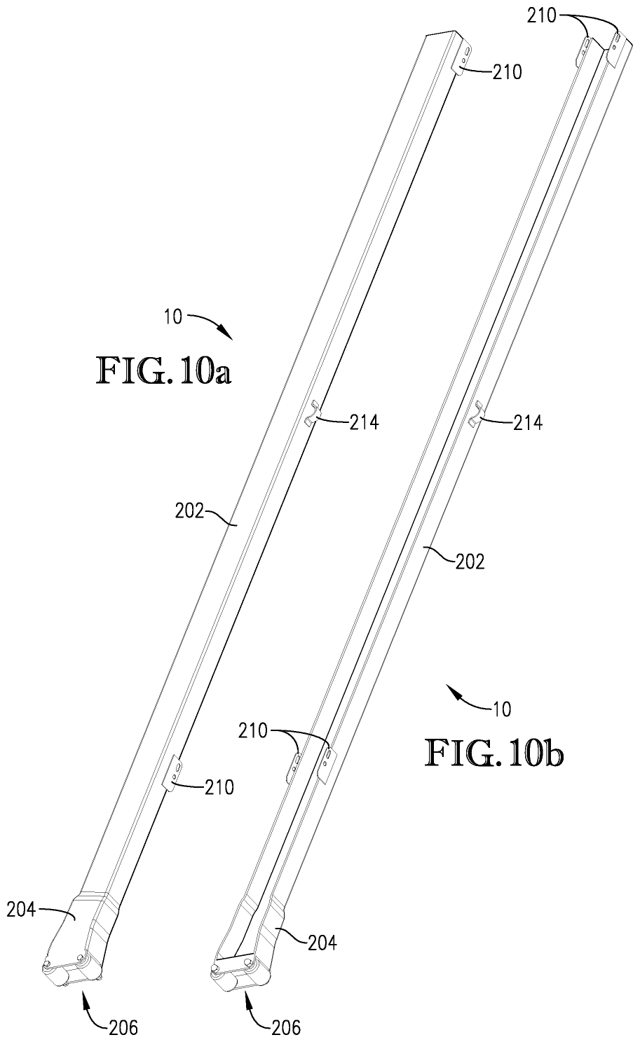

FIGS. 9-11 depict an alternative embodiment of the ladder support apparatus 10. Various structures or features of this embodiment may be incorporated into the above-discussed embodiments. FIG. 9 depicts the ladder 12 with the alternative embodiment of the ladder support apparatus 10 thereon. The ladder support apparatus 10 of this embodiment may comprise a pair of support rails 202 (best shown in FIGS. 10A and 10B) that, as will be described in more detail below, are configured to be fit over a portion of the support legs 16 of the ladder 12, so as to enhance mobility and to provide support and stability to the ladder 12. The support rails 202 function to create a reinforced rigidness for the legs of the ladder 12, so as to reduce or eliminate flexing of the support legs 16 when the ladder 12 is in use. Although illustrated as being separate components, embodiments may provide for the support rails 202 to be interconnected with each other for compactness during transport and storage. Each of the support rails 202 may be formed in the general shape of a structural channel (i.e., a C-channel), with a longitudinal main web and a pair of flange sections extending laterally from opposing sides of the main web. An upper end of each of the support rails 202 may be open. A lower end of each of the support rails 202 may be closed to form a boot 204 for receiving a foot 32 of the support leg 16 of the ladder 12. In some embodiments, the ladder support apparatus 10 may include one or more rollers 206 secured to a bottom surface of the support rail boots 204.

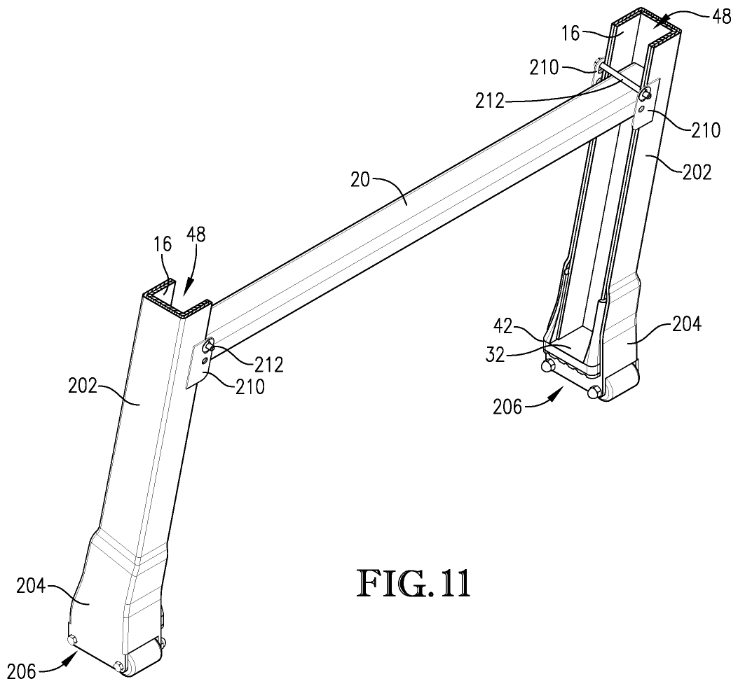

In general, the support rails 202 will be configured to fit or slide over a portion of the support legs 16 of the ladder 12, as shown in FIG. 11. Specifically, the open channel of each of the support rails 202 is configured to fit around an exterior side, a back side, and a front side of one of the support legs 16 of the ladder 12. Each foot 32 of the support legs 16 of the ladder 12 will fit down within the boot 204 of one of the support rails 202, and the support rail will extend upward along the support leg 16. The amount of upward extension will depend on a length of the support rail. However, in some embodiments, the support rail will be configured to extend just above the spreader 22, as shown in FIG. 9. As such, the support rails 202 may have varying lengths, but in some embodiments, the support rails 202 may be about six feet in length, so as to be capable of use with various sized ladders. In general, however, it should be understood that the inventive ladder support attachment is configured to be universal, such that the ladder support apparatus 10 can be used with generally any type of ladder type, ladder size, and/or ladder brand by sliding or otherwise positioning the ladder support apparatus 10 over the foot 32 of the support leg 16 of the ladder 12.

Embodiments provide for the ladder support apparatus 10 to be used on a given ladder 12 such that a support rail is positioned on each of the support legs 16. To secure the support rails 202 in position, the ladder support apparatus 10 may implement various method of attachment. For instance, as shown in FIG. 10A-B and 11, each of the support rails 202 may include a plurality of tab 210 pairs spaced along the length of the support rail. Although FIG. 11 only shows a single tab pair (with a single tab 210 extending from each flange section of the support rail), embodiments provide for the support rails 202 to include a plurality of tab pairs, such as shown in FIGS. 10A-B.

As best shown in FIG. 11, each of the tabs 210 may include a through hole, through which a pin 212 may be inserted. The through holes of the adjacent tab 210 pairs are aligned, such that a pin can be removably inserted through both of the tabs 210 of a give tab pair. The pin 212 may be disposed against a support rung 20 of the ladder 12 as shown. It is also contemplated that pairs of ladder support apparatus 10 may be stored or transported together by means of removably and/or releasably securing corresponding tab 210 pairs to each other. For instance, support rails 202 may be positioned adjacent one another such that through holes of corresponding tabs 210 of each ladder support apparatus 10 align so that the pin 212 may be removably inserted through both of the tabs 210 of separate ladder support apparatus 10 rails 202. In this manner, pairs of ladder support apparatus 10 may be releasably secured together to facilitate storage or transportation thereof.

In more detail, to secure a support rail on a support leg 16 of the ladder 12, the support rail can be positioned such that a lower tab pair is positioned directly above or below one of the lower, support rungs 20 of the ladder 12. In addition, an upper tab pair can be positioned directly above or below one of the higher, back rungs of the ladder 12, as shown in FIG. 9. In some embodiments, the upper tab pair will be positioned directly above the spreader 22. Regardless, a pin 212 can then be inserted between the openings of each of the tab pairs so as to secure the support rails 202 in place on the support legs 16 of the ladder 12. In some embodiments the tabs 210 may be located so as to secure the support rail from sliding along the leg of the ladder once a pin in inserted because of the placement of the tabs 210 in relation to upper and lower rungs of the ladder 12. In some embodiments, the tabs 210 may be oversized so as to include a plurality of through holes, so as to make securement to various styles and sizes of ladders more convenient.

It should be understood, however, that alternate or additional methods of securement may be used, such as those described above. For instance, in place of tabs 210, the flange sections of the support rails 202 be formed with notches that can receive a pin. Alternatively, in place of tabs 210, through-holes may be formed directly through the flange sections. Furthermore still, in place of the tabs 210, sliding securement components may be secured on the support rails 202, such that the securement components can slide upward and downward along the slide rails 202 to necessary positions at which the securement components can be used to secure the support rails 202 to the support legs 16 of the ladder 12. In even further embodiments, c-clamps, belts and latches, Velcro (e.g., hook and loop) straps, and other similar configurations of securement may be used.

Once the support rails 202 of the ladder support apparatus 10 are secured on the support legs 16 of the ladder 12, the ladder support apparatus 10 is configured to reinforce the ladder 12 so as to provide additional support and stability. In particular, as shown in FIG. 9, the support rails 202 are configured to fit snugly over the support legs 16 of the ladder 12. As such, the support rails 202 function to create a reinforced rigidness for the legs of the ladder 12, so as to reduce or eliminate flexing of the support legs 16 when the ladder 12 is in use.

In some embodiments, the interior surfaces of the support rails 202 will be in contact with the exterior surfaces of the support legs 16 of the ladder 12. In some embodiments, however, a small gap may be present between portions of the support rails 202 and the support legs 16 of the ladder 12. In further embodiments, the ladder support apparatus 10 may include one or more shims 208, as shown in FIG. 8B, which can be inserted between the support rails 202 and the legs of the ladder 12 to ensure contact between the surfaces. Such shims 208 may, in some embodiments, be secured in place via the tabs 210. Nevertheless, the support rails 202 will generally be formed from a rigid material (e.g., Steel, Aluminum, Fiberglass, or the like), such that the support rails 202 can impart structural rigidity to the ladder 12.

The boot 204, which is positioned at the lower end of the support rail and is configured to retain a foot 32 of the support leg 16 of the ladder 12, can provide support and stability to the ladder 12 by having a larger width than the foot 32 of the support leg 16 of the ladder 12. Specifically, the flange sections of the support rail may be flared outward at the boot 204, such that a width of the support rail is larger at the boot 204 than at the portion of the support rail above the boot 204. Such increased width provides for a broad base on which the ladder 12 can be supported, thereby increasing the support and stability of the ladder 12. The flare may also promote universal use of embodiments of the invention with additional ladders that may have rubber feet or the like. In addition, some embodiments provide for the boot 204 to extend somewhat rearwardly at an offset angle with respect to a general longitudinal direction of the support rail. Such rearward extension will provide a larger base for the overall ladder (i.e., between the primary and support legs 16 of the ladder 12), thereby increasing the support and stability of the ladder 12.

Furthermore, as is also shown in FIGS. 10A and 10B, certain embodiments provide for the support rails 202 to include rollers 206 extending downward from the bottom surface of the boot 204. The rollers 206 may be supported in position via a roller bracket that is rigidly secured to the boot 204. Specifically, the roller bracket may support one or more axles 134 about which the rollers 206 can rotate. Embodiments of the present invention may include axles (e.g., a bolt and nut securing one or more rollers 206 to a roller 130 bracket 100) that are removable to facilitate replacement of rollers 206 that may become worn through use. The ladder support apparatus 10 may include various numbers of rollers 206 on each support rail, such as one, two, or more rollers 206. The rollers 206 may be formed from various material having sufficient strength and durability, such as Delrin. Embodiments of the present invention provide for such rollers 206 to be used to improve mobility of the ladder 12. Specifically, as the support rails 202 are secured to the support legs 16 of the ladder 12, the ladder 12 can be tilted rearward, such that the ladder 12 is fully supported by the rollers 206. In such an orientation, the ladder 12 can be easily maneuvered by rolling the ladder 12 on the ground surface via the rollers 206. In addition, with the rollers 206 on the support legs 16 of the ladder 12, the support legs 16 are compelled to spread apart, away from the support legs 16, when the ladder 12 is in use (e.g., when an individual is climbing the ladder 12) so as to improve support and stability of the ladder 12 by providing improved contact of the legs with the ground surface. Such improved contact of the legs reduces wobble of the ladder 12 during use and inhibits “walking” of the ladder 12, which is a known problem for standard ladders.

As shown in FIG. 9, in some embodiments of the invention, a set of anchors 214 may be disposed on the rail 202. The anchors 214 are each configured to support a security strap 216 between the respective primary leg 14 and the support leg 16 of the ladder 12. The anchors 214 provide an opening to which the security strap 216 may be secured. The security strap 216 may then be secured to the primary leg 16 such as by wrapping around the primary leg 16 and securing the security strap 216 to itself (not directly illustrated). The security strap 216 may be a ratchet strap, an elastic strap, or other adjustable strap. The security strap 216 relieves or reduces strain on the spreader 22. The reduced strain will reduce the likelihood and severity of failures at the spreader 22. Absent the security strap 216, a failure at the spreader 22 could cause the ladder to collapse and injure the user. It should also be appreciated that the security strap 216 and/or the anchors 214 may be used in combination with any of the above-discussed embodiment of the invention.

### ADDITIONAL CONSIDERATIONS

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

Although the present application sets forth a detailed description of numerous different embodiments, it should be understood that the legal scope of the description is defined by the words of the claim(s) set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

We claim:

1. A ladder support apparatus for providing support and stability to a ladder, said ladder support apparatus comprising:
a bracket configured to be secured to a leg of the ladder;
a friction-reducing segment secured to the bracket;
a friction-inducing segment secured to the bracket,
wherein the friction-inducing segment is configured to interface with an underlying surface when the ladder support apparatus is in a default orientation relative to the underlying surface,
wherein the friction-reducing segment is configured to interface with the underlying surface when the ladder support apparatus is in an angled orientation relative to the underlying surface.

2. The ladder support apparatus of claim 1, wherein the bracket includes:
a lateral support plate configured to receive a foot of the leg of the ladder thereon;
a first sidewall extending downward from the lateral support plate; and
a second sidewall extending downward from the lateral support plate.

3. The ladder support apparatus of claim 2, wherein the bracket includes:
a securing fastener configured to exert a force of the foot; and
an alignment plate extending upward from the lateral support plate,
said alignment plate configured to keep the foot aligned with the bracket.

4. The ladder support apparatus of claim 2,
wherein the friction-reducing segment includes a roller rotatable about an axis running between the first sidewall and the second sidewall,
wherein the roller enhances mobility of the ladder by allowing the ladder to roll.

5. The ladder support apparatus of claim 1, wherein the friction-inducing segment includes:
a frictional pad configured to reduce mobility of the ladder when the ladder is in the default orientation, such that the user may climb the ladder.

6. The ladder support apparatus of claim 5, wherein the friction-inducing segment further includes:
a positioning segment configured to keep the frictional pad at a set distance relative to the bracket,
wherein the set distance is determined based at least in part on the angled orientation of the ladder.

7. The ladder support apparatus of claim 6,
wherein the bracket includes a lateral support plate having an opening therein,
wherein the positioning segment includes a fastener with helical protrusions disposed at least partially through said opening,
wherein rotation of the fastener relative to the lateral support plate places the frictional pad at the set distance relative to the lateral support plate.

8. A ladder support apparatus for providing support and stability to a ladder, said ladder support apparatus comprising:
a bracket configured to be secured to a leg of the ladder,
said bracket including
a lateral support plate configured to receive a foot of the leg of the ladder thereon;
a first sidewall extending downward from the lateral support plate;
a second sidewall extending downward from the lateral support plate;
a friction-reducing segment secured to the bracket;
a friction-inducing segment secured to the bracket,
wherein the friction-inducing segment is configured to interface with an underlying surface when the ladder support apparatus is in a default orientation relative to the underlying surface,
wherein the friction-reducing segment is configured to interface with the underlying surface when the ladder support apparatus is in an angled orientation relative to the underlying surface.

9. The ladder support apparatus of claim 8, wherein the bracket further includes:
a securing fastener configured to exert a force of the foot; and
an alignment plate extending upward from the lateral support plate,
said alignment plate configured to keep the foot aligned with the bracket.

10. The ladder support apparatus of claim 8,
wherein the friction-reducing segment includes a roller rotatably secured between the first sidewall and the second sidewall,
wherein the roller enhances mobility of the ladder by allowing the ladder to roll while the ladder support device is in the angled orientation relative to the underlying surface.

11. The ladder support apparatus of claim 8, wherein the friction-inducing segment includes:
a frictional pad configured to reduce mobility of the ladder when the ladder is in the default orientation, such that the user may climb the ladder.

12. The ladder support apparatus of claim 11, wherein the friction-inducing segment further includes:
a positioning segment configured to keep the frictional pad at a set distance relative to the lateral support plate,
wherein the set distance is determined based at least in part on the angled orientation of the ladder.

13. The ladder support apparatus of claim 12,
wherein the lateral support plate includes an opening
wherein the positioning segment includes a fastener with helical protrusions disposed at least partially through said opening,
wherein rotation of the fastener relative to the lateral support plate places the frictional pad at the set distance relative to the lateral support plate.

14. A ladder support system for providing support and stability to a ladder, wherein the ladder includes a set of primary legs and a set of support legs, said ladder support system comprising:
a first ladder support apparatus having a first orientation configured to be secured to a first support leg of the set of support legs of the ladder; and
a second ladder support apparatus having a second orientation configured to be secured to a second support leg of the set of support legs of the ladder,
wherein the first orientation is mirrored relative to the second orientation,
said first ladder support apparatus and said second ladder support apparatus each including:
a bracket configured to be secured to the respective support leg of the ladder;
a friction-reducing segment secured to the bracket;
a friction-inducing segment secured to the bracket,
wherein the friction-inducing segment is configured to interface with an underlying surface when the ladder support apparatus is in a default orientation relative to the underlying surface,
wherein the friction-reducing segment is configured to interface with the underlying surface when the ladder support apparatus is in an angled orientation relative to the underlying surface.

15. The ladder support system of claims 14, wherein each bracket includes:
a lateral support plate configured to receive a foot of the leg of the ladder thereon;
a first sidewall extending downward from the lateral support plate; and
a second sidewall extending downward from the lateral support plate.

16. The ladder support system of claim 15, wherein each bracket includes:
a securing fastener configured to exert a force of the foot; and
an alignment plate extending upward from the lateral support plate,
said alignment plate configured to keep the foot aligned with the bracket.

17. The ladder support system of claim 15,
wherein each friction-reducing segment includes a roller rotatable about an axis running between the first sidewall and the second sidewall,
wherein each roller enhances mobility of the ladder by allowing the ladder to roll.

18. The ladder support system of claim 14, wherein each friction-inducing segment includes:
a frictional pad configured to reduce mobility of the ladder when the ladder is in the default orientation, such that the user may climb the ladder.

19. The ladder support system of claim 18, wherein each friction-inducing segment further includes:
a positioning segment configured to keep the frictional pad at a set distance relative to the bracket,
wherein the set distance is determined based at least in part on the angled orientation of the ladder.

20. The ladder support system of claim 19,
wherein each bracket includes a lateral support plate having an opening therein,
wherein each positioning segment includes a fastener with helical protrusions disposed at least partially through said opening, wherein rotation of the fastener relative to the lateral support plate places the frictional pad at the set distance relative to the lateral support plate.
